(19) United States
(12) Patent Application Publication
(10) Pub. No.: US 2022/0232871 A1
(43) Pub. Date: Jul. 28, 2022

(54) NATURAL COMPOSITE MATERIALS DERIVED FROM SEAWEED AND METHODS OF MAKING THE SAME

(71) Applicant: HEALTHALL LABORATORY, INC., Pasadena, CA (US)

(72) Inventor: Lijun SUN, La Canada Flintridge, CA (US)

(21) Appl. No.: 17/620,029

(22) PCT Filed: Jun. 19, 2020
(86) PCT No.: PCT/US2020/070160

§ 371 Date: Dec. 16, 2021

Related U.S. Application Data
(60) Provisional application No. 62/865,051, filed on Jun. 21, 2019.

(51) Int. Cl. A23L 29/256; A23L 17/60; C08B 37/00; C08L 5/12

(52) U.S. Cl. CPC A23L 29/256; A23L 17/60; A23V 2002/00; C08L 5/12; C08B 37/0039

(57) ABSTRACT

Provided are natural seaweed composite materials comprising one or more insoluble fibers and agar associated with the insoluble fiber. The natural seaweed composite materials are produced by methods comprising high pressure homogenization which maintains the natural complex structure of the insoluble fiber and the agar as in natural unprocessed seaweeds.

### CROSS-REFERENCE TO RELATED APPLICATIONS

This application claims the benefit of U.S. Provisional Patent Application No. 62/865,051, filed Jun. 21, 2019, which is incorporated herein by reference in its entirety.

### TECHNICAL FIELD

This disclosure relates to natural composite materials derived from seaweed and methods of making the same. The natural composite material disclosed herein comprises agar and insoluble fiber structurally associated with each other.

### BACKGROUND

Seaweed is a rich source of marine biomaterials with a wide range of applications in food, nutrition, cosmetic and health industries. Among its many components, including lipids, proteins, insoluble fibers such as cellulose, minerals, vitamins, and natural colorants, phycocolloids (including agar, carrageenan, and alginates) have been the major commercial seaweed extracts. While some species of seaweed are edible as food ingredient, others such as Gelidium and Gracilaria contain rough and crude insoluble fibers resulting in poor mouthfeel. The main use of these seaweeds is to extract soluble phycocolloids, while the rest of seaweed residues, including the crude insoluble fiber, is discarded or used as low value materials such as fertilizers. Therefore, there is a need in the field to fully develop and use seaweeds for natural composite materials, particularly high quality natural composite materials suitable for food applications.

### SUMMARY

In one aspect, provided herein is a natural seaweed composite material. In some embodiments, the natural seaweed composite material is obtained from red algae. In some embodiments, the natural seaweed composite material is obtained from agarophytic red algae. The natural seaweed composite material comprises one or more insoluble fibers and agar, wherein the agar is associated with the insoluble fiber. The association between the agar and the insoluble fiber is substantially the same as the association between the agar and the insoluble fiber in natural seaweed before being processed. In some embodiments, the insoluble fiber includes cellulose and insoluble hemicellulose. In some embodiments, the agar is bound to the surface of the insoluble fiber such as cellulose of the natural seaweed composite material. In some embodiments, the insoluble fiber is partially or entirely encapsulated by agar. In some embodiments, the insoluble fiber is entirely or partially embedded within agar. In some embodiments, the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm. In some embodiments, the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.

In another aspect, provided herein is a method of making a natural seaweed composite material from red algae. The method comprises the steps of treating the fresh or dried seaweed with one or more acids, grinding the acid-treated seaweed by wet milling or dry grinding, subjecting the ground seaweed to high pressure homogenization (HPH), and drying and grinding the homogenized seaweed to a desired particle size to obtain the natural seaweed composite material. In certain embodiments, the HPH is carried out under conditions and temperature without melting agar and dissociating agar from its natural seaweed matrix. In some embodiments, the HPH is carried out at a temperature of between 0° C. and 85° C. such as between 20° C. and 75° C. In some embodiments, the HPH is carried out at a temperature of between 0° C. and 50° C. such as between 20° C. and 40° C. In some embodiments, the HPH is carried out at a temperature of between 25° C. and 30° C. In some embodiments, the HPH is carried out at room temperature. The obtained natural seaweed composite material has a low gelling strength and a high molecular weight. For example, the obtained natural seaweed composite material has an average molecular weight of 100-1000 kDa, and/or a gelling strength of 10-400 g/cm² at 1.5%. In some embodiments, the seaweed is washed and/or cleaned to remove debris before the acid treatment. In some embodiments, the seaweed is bleached by one or more bleaching agents before HPH.

In some embodiments, the method comprises a step of treating the fresh or dried seaweed with one or more alkalis before the acid treatment to obtain a natural seaweed composite material having a high gelling strength and a high molecular weight. For example, the obtained natural seaweed composite material has an average molecular weight of 100-1000 kDa, and/or a gelling strength of 200-1000 g/cm² at 1.5%. In some embodiments, the method including the alkali-pretreatment step further comprises a step of a second acid treatment after HPH treatment to obtain a natural seaweed composite material having a low gelling strength and a low molecular weight. For example, the obtained natural seaweed composite material has an average molecular weight of 10-100 kDa, and/or gelling strength of 10-200 g/cm² at 1.5%.

In a related aspect, provided herein is a natural seaweed composite material produced by any of the methods described above. The natural seaweed composite material comprises one or more insoluble fibers and agar, wherein the agar is associated with the insoluble fiber. In some embodiments, the insoluble fiber includes cellulose and insoluble hemicelluloses. In some embodiments, the insoluble fiber is associated with agar in a manner similar to the association in the natural state in seaweed before processing. In some embodiments, agar is bound to the surface of the insoluble fiber such as cellulose of the natural seaweed composite material. In some embodiments, the insoluble fiber is entirely or partially embedded within agar. In some embodiments, the insoluble fiber is partially or entirely encapsulated by agar. In some embodiments, the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm. In some embodiments, the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.

### BRIEF DESCRIPTION OF THE DRAWINGS

This application contains at least one drawing executed in color. Copies of this application with color drawing(s) will be provided by the Office upon request and payment of the necessary fees.

FIG. 1 shows the results of the suspension stability test of Sample A-1 (no HPH control) and Sample A-2 (normal temperature HPH).

FIGS. 2A-2C show an imaging analysis of Sample A-2, with a view of a larger ensemble of particles (FIG. 2A), a view of more spread-out particles (FIG. 2B), and a zoomed-in view of a few particles showing the insoluble fiber (arrow-pointed brighter colored region) and agar (arrow-pointed opaque region) in the natural composite material.

FIGS. 3A and 3B show comparative imaging analysis of different seaweed composite material samples by light microscope (FIG. 3A) and scanning electron microscope (SEM) (FIG. 3B), respectively.

FIG. 4 shows comparative imaging analysis of cellulose fibers in different seaweed composite materials samples.

FIGS. 5A and 5B show particle size analyses of Sample A-2 at room temperature (FIG. 5A) and at 60° C. (FIG. 5B), respectively.

### DETAILED DESCRIPTION

Natural seaweed composite materials and methods for making such natural seaweed composite materials are provided herein. The methods result in natural seaweed composite materials in which the natural association between the insoluble fiber and agar is maintained without any substantial dissociation of the agar from the insoluble fiber. The obtained natural seaweed composite material comprises one or more insoluble fibers and agar associated with the insoluble fiber.

As used herein, “associated” or “association” means that the agar is bound to the surface of the insoluble fiber, the insoluble fiber is partially or entirely encapsulated by the agar, or the insoluble fiber is partially or entirely embedded within the agar. In some embodiments, the insoluble fiber forms a “bundled” fiber core, with the agar bound to the surface of the insoluble fiber core in the natural seaweed composite material. In some embodiments, the structure of the insoluble fiber is disrupted without melting and dissociating the agar from the insoluble fiber. As used herein, “disruption” of the insoluble fiber means that the densely packed or “bundled” structure of the insoluble fiber in its natural state in unprocessed seaweed is changed into a loose and disorganized structure after the seaweed being subjected to the process steps disclosed herein, resulting the natural seaweed composite material wherein the structural modified algae insoluble fiber remains bound by agar.

The terms “seaweed,” “algae” and “marine algae” may be used interchangeably in this disclosure to mean marine plants or macroalgae and include red algae, brown algae, and green algae.

### I. Composition of the Natural Seaweed Composite Material

Agar is a major phycocolloid extracted from certain species of red seaweed including Gelidium and Gracilaria. Due to its unique gelling properties and stability, agar is widely used in food, cosmetics and pharmaceutical/biotechnological industries. In food industry, agar is used as a thickener, gelling agent, texturizer, moisturizer, emulsifier, and flavor enhancer. Agar is also considered a soluble dietary fiber that is undigestible by human but possesses a range of health promoting activities including serving as intestinal regulator.

Agar is generally composed of agarose and agaropectin. Agarose is a linear polymer made of the repeating units of agarobiose, a disaccharide of D-galactose and 3,6-anhydro-L-galactopyranosec, although some L-galactose units in the polymer may not contain the 3,6-anhydro bridge. Agaropectin, accounting for ˜30% agar composition, refers collectively to a heterogeneous mixture of natural compounds, including sulfated polysaccharides, galactan, ester sulfates, D-glucuronic acid and small amounts of pyruvic acid. Some D-galactose and L-galactose units may be methylated. Although some components of agaropectin have been reported to possess health benefits, most of these natural compounds in seaweeds are discarded in commercial process of extracting agar. Thus, a process of extracting agar for its gelling function while having the option to selectively retain certain natural components of seaweed would increase the value and applications of seaweed.

Agar is traditionally extracted from red seaweed by hot water, which melts and dissociates agar from its natural plant matrix including the cellulose fiber skeleton. After filtering off the insoluble residues, agar is isolated by gelling and dehydration processes. The gelling properties of agar can be adjusted for various applications. While alkali treatment is generally used to desulfate native agar and increase the gelling strength, acid treatment can reduce the molecular weight of agar and its gelling strength. Agar exhibits the phenomenon of thermal hysteresis in its liquid-to-gel transition, i.e. it gels and melts at different temperatures. The gelling and melting temperatures vary depending on the type of agar and its concentration. The melting temperature of agar is intrinsically related to its structure, modifications and compositions. The agar extracted by boiling water and a gelling process may be different from native agar bound to seaweed cell wall in terms of its structure, functions, and properties.

Although agar has been extracted from red seaweed for hundreds of years and has been refined by various processes to adjust gelling properties for a wide range of applications, all of these processes depend on hot water extraction of soluble agar from its native context, leaving most of other seaweed components unused, many of which may have valuable functions as food ingredients and health supplements. The conventional agar extraction process also involves the formation of agar gel that traps large amount of water, making the dehydration process a high energy-consuming and less efficient process. Moreover, the agar extracted by the conventional processes generally forms a very stable structure that requires higher energy to disrupt; hence the obtained agar has a higher melting temperature.

There are seaweed meals known in the art that are processed by cleaning, drying and grinding the dried seaweed into powdered form, or by conditioning the seaweed in water with various substances and digesting by cooking with steam to form steam-digested mixture that is ultimately made into seaweed cakes. Seaweed meals or seaweed cakes made by these approaches have poor gelling capability, poor flavor and mouthfeel, especially for products made from seaweed species with relatively high content of insoluble cellulose fiber up to 35%. Although simple pulverization treatment can reduce the particle size of the crude seaweed fiber, its internal structure and hard texture are not significantly altered, leading to poor mouthfeel, low water binding capacity and low quality as dietary fiber. Steam-cooking has all the drawbacks of heating associated with traditional agar extraction by boiling water and the crude fiber is not efficiently processed to improve mouth feel and water retention capacity. As a result, seaweed products made by the above prior-art known approaches are neither suitable for use as gelling agent nor high quality dietary fiber in food applications.

In sum, agar is a main product extracted from red seaweed by heating with boiling water, although other seaweed components such as cellulose, lipids, and natural colorants have also been isolated for various applications. All of these conventional processes are characterized by separation and refinement of one single specific component. In contrast, the technology disclosed herein contributes an improvement to the field such that two or more seaweed components can be isolated together, preferably in their native complex or associated state, using efficient and versatile processes that allow refinement of one or more of the components to improve food quality and nutritional value.

The red seaweed cell wall is made mainly by agar and cellulose, both of which are of high value in food applications as described above. Seaweed may contain up to 75% of its dry weight dietary fiber, of which up to 85% could be water soluble fiber. Within this range, the total weight fraction of dietary fiber and the ratio between soluble and insoluble fiber vary depending on the specific seaweed species and growing conditions. In agarophytic red seaweed, the main soluble fiber is agar while the main insoluble fiber is cellulose and insoluble hemicelluloses with residual amount of other insoluble polysaccharides such as mannan and xylan. Cellulose is a polysaccharide polymer of β(1-4) linked D-glucose found in the cell wall of plants and algae. The cellulose polymer chains assemble together to form protofibrils, which further pack against each other to form higher-order cellulose fiber structure. The packing arrangement vary depending on the sources. For example, cellulose fiber from Algae has different structural characteristics from that of terrestrial plants. However, cellulose fiber from closely related species generally share similar structure and property. The present disclosure relates to a novel approach to break down the cell wall of red seaweed, expose agar for direct use or for further refinement to improve gelling function while maintaining agar in its natural state of association with the insoluble fiber. Although not wish to be bound by theory, the elasticity of the agar and/or its porous structure may allow the cellulose fiber to be broken down by high pressure homogenization (HPH) or similar methods while remain bound to agar, thereby to obtain the natural agar-cellulose fiber composite materials disclosed herein. For example, while remaining bound to agar, the cellulose fiber can be modified by chemical and/or mechanical processes to improve its water binding and retention capacity. All the processes can be carried out without heating and melting to dissociate agar from its natural complex with cellulose, allowing substantially maintaining agar in its native state of binding to cellulose and possibly retaining other natural components (e.g. agaropectin molecules). Moreover, the novel process is much more efficient and simplified compared with the traditional agar extraction process by boiling water. The final product disclosed herein is a natural composite of agar bound to cellulose fiber that has both the gelling properties of agar and physiological function of dietary fibers. The melting point of the natural agar is about 5-10° C. lower than the heat-extracted agar, an advantage in applications where a low melting temperature is desired.

The seaweed cell wall is made primarily of an agar and cellulose complex with other natural marine compositions. Instead of separating agar from cellulose in a conventional boiling water extraction, the technology disclosed herein entails breaking down seaweed cell wall such that a natural composite material where agar is in its native state bound to the cellulose can be obtained. The seaweed composite material disclosed herein comprises natural agar which never undergoes melting and gelling in the process. The disclosed process can optionally retain certain natural compounds bound within agar-cellulose composite materials. Examples of these compounds include but are not limited to natural antioxidants, vitamins, minerals, or components of agaropectin. The composite agar-cellulose materials can be processed into particle size less than or about 90 μm, wherein the cellulose fiber is less than or about 15 μm. The composite material particles have a general structure of agar encapsulating or embedding the cellulose fiber although some particles have cellulose fiber exposed at the edge. The agar located at the surface of the composite particles has gelling function and the gelling properties can be modified by various methods, including alkali and acid treatment. Therefore, the disclosed natural agar-cellulose composite materials can replace agar in many food applications. The insoluble cellulose fiber in the composite materials is also structurally modified by size reduction along the fiber axis and by breaking down the fiber bundle perpendicular to the fiber axis. Therefore, the insoluble cellulose fiber has much increased surface area, better water binding and retention capacity and is stable in water after agar is melted and dissociated from the cellulose fiber. These new structural features and functional enhancements make the agar-cellulose composite materials disclosed herein a great source of dietary fiber. Because the agar-cellulose composite material is processed from seaweed without melting and gelling of the agar, the dehydration of the final product is much simplified and efficient than the traditional agar making process. The agar in the disclosed agar-cellulose composite materials has a melting point that is 5-10° C. lower than agar extracted by the conventional protocol using boiling water to melt the agar.

### II. Processes of Making the Natural Seaweed Composition Materials

The process in general includes the steps of treating the seaweed by one or more alkalis and/or one or more acids to obtain the materials having desired gelling properties. The bleaching step is optional to remove the natural color of the seaweed product, if desired. The seaweed is subjected to preliminary grinding including dry grinding or wet milling, high pressure homogenization under room temperature, and drying and grinding into the final agar-cellulose composite materials having a desired particle size. If desired, the high pressure homogenization can be carried out at a higher temperature to melt the agar, and the process further requires gelling by cooling and dehydration of the agar gel. The seaweeds suitable for this disclosure include all fresh or dried red algae belonging to the Rhodophyceae class, also known as the agarophytes or agar-containing seaweeds, Examples include but are not limited to, Gracilaria, Gelidium, Porphyra, Pterocladia, Ahnfeltia, Gelidium micropterum, Gelidium pusillum, Gelidiella acerosa, Gelidiopsis variabilis. Gracilaria edulis, Gracilaria Salicornia, Gracilaria dura, Gracilaria corticate, G. corticate v. cylindrica, Gracilaria folifera, Gracilaria textorii, Gracilaria fergusonii, Gracilaria crassa. Gracilaria debilis, Gracilaria verrucose, and Gelidium corneum, or a combination of two or more of the above species of red algae. The specific details of the process may vary depending on the different starting raw materials and the desired features of the final product. Based on the different acid and/or alkali treatments, the manufacturing processes of the agar-cellulose composite materials can be classified into three different categories as following.

Process 1 Alkali Treatment Followed by Acid Treatment

### A. Dry Grinding Before High Pressure Homogenization

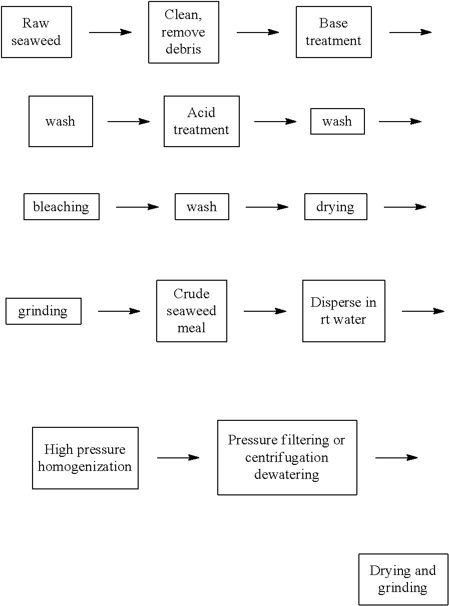

(1) The raw fresh or dried seaweed is cleaned by washing and removing debris;
(2) The cleaned seaweed is treated with an alkali solution, followed by a wash with water to a neutral pH to obtain alkali-treated seaweed;
(3) The alkali treated seaweed is treated with an acid solution, followed by a wash to a neutral pH;
(4) Optionally, the acid-treated seaweed is treated with one or more bleaching agents, followed by a wash to remove the bleaching agent;
(5) The obtained seaweed is dehydrated and dried to a water content of less than or about 20%, and pulverized to 80 mesh or more to obtain a crude seaweed powder;
(6) The crude seaweed powder is dispersed in water at a temperature of 0-85° C. and then processed by high-pressure homogenization at a pressure of 10-100 MPa, and then subjected to pressure filtration or centrifugal dewatering, and dried to a water content of 20% or less; and
(7) The dried seaweed is pulverized to 80 mesh or more to obtain the final seaweed composite material.

### B. Colloid Miffing Before High Pressure Homogenization

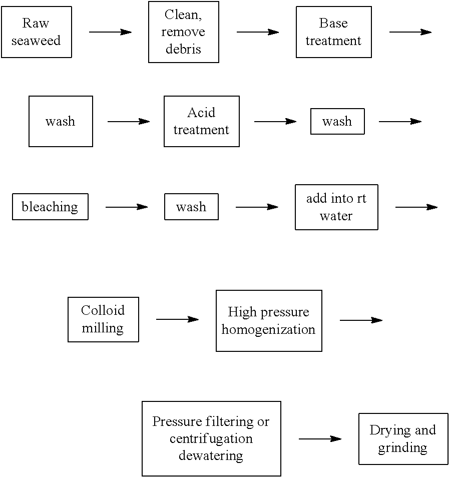

(1) The raw fresh or dried seaweed is cleaned by washing and removing debris;
(2) The cleaned seaweed is treated with an alkali solution, followed by a wash with water to a neutral pH to obtain alkali-treated seaweed;
(3) The alkali treated seaweed is treated with an acid solution, followed by a wash to a neutral pH;
(4) Optionally, the acid-treated seaweed is treated with one or more bleaching agents, followed by a wash to remove the bleaching agent;
(5) The seaweed is added to water at a temperature of 0-85° C. and wet milled by colloid milling;
(6) The milled seaweed is processed by high-pressure homogenization at a pressure of 10-100 MPa, and then subjected to pressure filtration or centrifugal dewatering, and dried to a water content of 20% or less; and
(7) The dried seaweed is pulverized to 80 mesh or more to obtain the final seaweed composite material.

The alkali treatment can increase the gelling strength of agar or agar-containing seaweed composite material. There is a correlation between the content of sulfate in the raw seaweed and the degree of alkali treatment and gelling strength. For different species of seaweeds, the contents of sulfate are also different: the less sulfate, the stronger the gelling strength. Alkali treatment results in a higher degree of desulfation and greater gelling strength.

Seaweed composite materials prepared from different red algae species can have very different gelling strength. In general, seaweed composite materials prepared by alkali treatment of different species of seaweeds have a gelling strength range of 200-1000 g/cm² and an average molecular weight of 100-1000 kDa.

Seaweed composite materials prepared according to Process 1 disclosed above is characterized by containing a high molecular weight agar and a high gelling strength. These seaweed composite materials are suitable for the preparation of gelling foods, such as fruit jelly, pudding, gelatin candy, yogurt, etc., due to their good gelling function and thickening effect.

Process 2 Acid Treatment without Alkali Treatment

### A. Dry Grinding Before High Pressure Homogenization

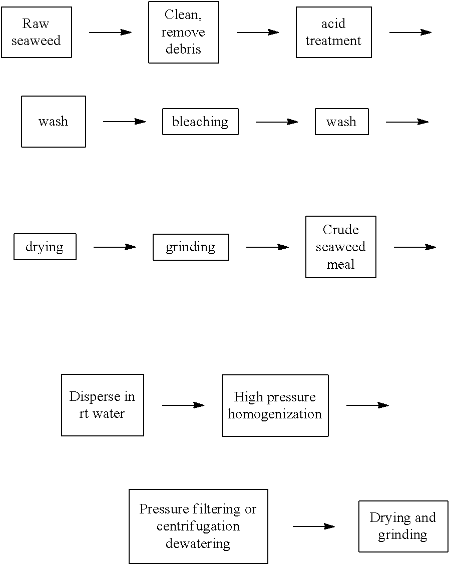

(1) The raw fresh or dried seaweed is cleaned by washing and removing debris;
(2) The cleaned seaweed is treated with an acid solution, followed by a wash to a neutral pH;
(3) Optionally, the acid-treated seaweed is treated with one or more bleaching agents, followed by a wash to remove the bleaching agent;
(4) The obtained seaweed is dehydrated and dried to a water content of less than or about 20%, and pulverized to 80 mesh or more to obtain a crude seaweed powder;
(5) The crude seaweed powder is dispersed in water at a temperature of 0-85° C. and then processed by high-pressure homogenization at a pressure of 10-100 MPa, and then subjected to pressure filtration or centrifugal dewatering, and dried to a water content of 20% or less; and
(7) The dried seaweed is pulverized to 80 mesh or more to obtain the final seaweed composite material.

### B. Colloid Miffing Before High Pressure Homogenization

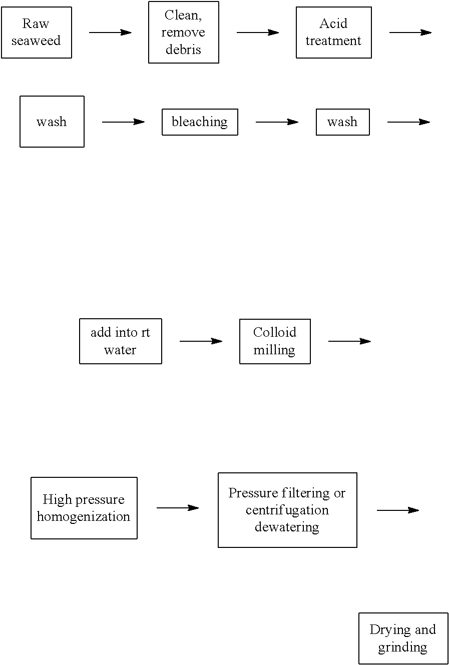

(1) The raw fresh or dried seaweed is cleaned by washing and removing debris;
(2) The cleaned seaweed is treated with an acid solution, followed by a wash to a neutral pH;
(3) Optionally, the acid-treated seaweed is treated with one or more bleaching agents, followed by a wash to remove the bleaching agent;
(4) The seaweed is added to water at a temperature of 0-85° C. and wet milled by colloid milling;
(5) The milled seaweed is processed by high-pressure homogenization at a pressure of 10-100 MPa, and then subjected to pressure filtration or centrifugal dewatering, and dried to a water content of 20% or less; and
(6) The dried seaweed is pulverized to 80 mesh or more to obtain the final seaweed composite material.

When the seaweed is not subjected to alkali treatment or excessive acid treatment, the molecular weight of agar is likely maintained yet the gelling strength is low. Seaweed composite materials prepared by this acid treatment only process have high molecular weight but low gelling strength, resulting in a high viscosity and a good water retention property.

The gelling strength of seaweed composite materials prepared by the technology disclosed herein also depends on the type of red algae species. Among them, Gracilaria can be used to prepare seaweed composite materials having a gelling strength of 10-300 g/cm². Due to its low sulfate content, Gelidium can be used to prepare seaweed composite materials having a gelling strength ranging from 100 to 400 g/cm². This type of seaweed composite material is characterized by a large molecular weight of agar having an average molecular weight of 100-1000 kDa, a low gelling strength, and a high viscosity; thus, is suitable for preparing foods requiring high water retention but low gelling strength, such as various sauces, pastes, drinks, etc.

Process 3 Alkali Treatment Followed by Double Acid Treatments

### A. Dry Grinding Before High Pressure Homogenization

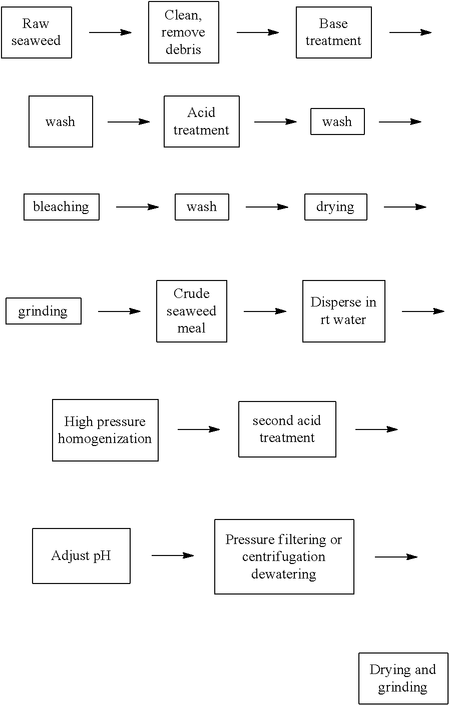

(1) The raw fresh or dried seaweed is cleaned by washing and removing debris;
(2) The cleaned seaweed is treated with an alkali solution, followed by a wash with water to a neutral pH to obtain alkali-treated seaweed;
(3) The alkali treated seaweed is treated with an acid solution, followed by a wash to a neutral pH;
(4) Optionally, the acid-treated seaweed is treated with one or more bleaching agents, followed by a wash to remove the bleaching agent;
(5) The obtained seaweed is dehydrated and dried to a water content of less than or about 20%, and pulverized to 80 mesh or more to obtain a crude seaweed powder;
(6) The crude seaweed powder is dispersed in water at a temperature of 0-85° C. and then processed by high-pressure homogenization at a pressure of 10-100 MPa;
(7) The homogenized liquid is treated with an acid solution (0.1-3% w/w) for 5-20 hours at a temperature of 0-85° C., followed by adjusting the pH to neutral with an alkali;
(8) The sample is subjected to pressure filtration or centrifugal dewatering, and dried to a water content of 20% or less; and
(9) The dried seaweed is pulverized to 80 mesh or more to obtain the final seaweed composite material.

### B. Colloid Miffing Before High Pressure Homogenization

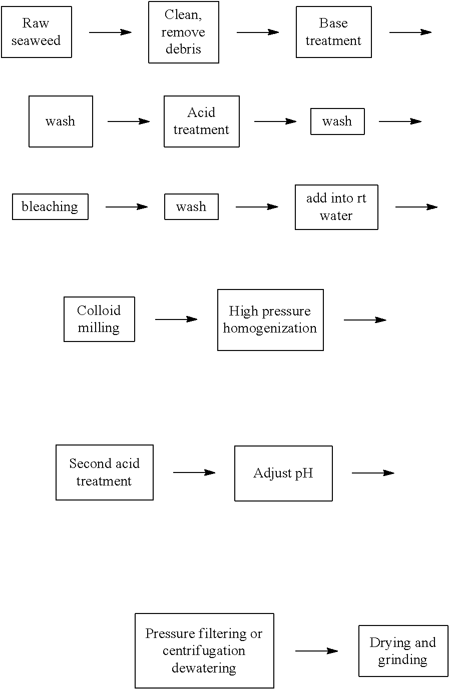

(1) The raw fresh or dried seaweed is cleaned by washing and removing debris;
(2) The cleaned seaweed is treated with an alkali solution, followed by a wash with water to a neutral pH to obtain alkali-treated seaweed;
(3) The alkali treated seaweed is treated with an acid solution, followed by a wash to a neutral pH;
(4) Optionally, the acid-treated seaweed is treated with one or more bleaching agents, followed by a wash to remove the bleaching agent;
(5) The seaweed is added to water at a temperature of 0-85° C. and wet milled by colloid milling;
(6) The milled seaweed is processed by high-pressure homogenization at a pressure of 10-100 MPa;
(7) The homogenized liquid is treated with an acid solution (0.1-3% w/w) for 5-20 hours at a temperature of 0-85° C., followed by adjusting the pH to neutral with an alkali;
(8) The sample is subjected to pressure filtration or centrifugal dewatering, and dried to a water content of 20% or less; and
(7) The dried seaweed is pulverized to 80 mesh or more to obtain the final seaweed composite material.

To obtain a low gelling strength seaweed composite material, it is possible to use an acid to reduce the molecular weight of agar. The seaweed composite material prepared by this process has a low molecular weight and a low viscosity. This type of the seaweed composite material has a good thickening property and can be used to make pastes with a uniform, fine and smooth texture.

Seaweed can be treated with one or more alkalis to obtain seaweed composite materials having a large molecular weight and a strong gelling strength. It can be further treated with one or more acids at a low temperature for a long period of time or at a high temperature for a short period of time to reduce the molecular weight of the water-soluble polysaccharides such as agar, thereby to reduce the gelling strength of the seaweed composite materials.

Seaweed composite materials made according to Process 3 generally have a gelling strength of 10 to 200 g/cm². This type of seaweed composite material is characterized by a low molecular weight of water-soluble polysaccharides such as agar, with an average molecular weight of 10-100 kDa, a low gelling strength, and a good thickening effect but not sticky. This type of seaweed composite material is suitable for food applications such as yoghurt, pudding, beverages, etc.

For all three processes disclosed herein, a sample of each intermediate product before HPH was saved and added to hot water to melt and dissociate the agar from the cellulose matrix and then the HPH was performed at a higher temperature (60-100° C.), followed by cooling, gelling and dehydration. The cellulose fiber can be broken down more efficiently at a higher temperature, or the cellulose fiber can be efficiently broken down at room temperature with more stringent HPH conditions (e.g. higher pressure or multiple passes). There are recognizable differences in the agar-cellulose composite materials obtained by these two different ways. HPH at room temperature results in much more evenly distributed agar-cellulose composite particles with grainy particles containing cellulose fiber mostly encapsulated by agar. On the other hand, HPH under high temperature results in a sample that is highly variable in particle sizes and shapes, where some particles seem to have large amount cellulose fiber surrounded by a thin layer of agar, and others seem to be made mostly of agar without fibers. This sample also contains many flakes of agar gel pieces. These observations suggest that HPH under high temperature causes the melting and dissociation of agar. During the cooling and gelling process, some cellulose fiber particles associate to each other to form large clusters in the agar gel, leaving some region with high content of cellulose and other regions devoid of cellulose.

Thus, the disclosed technology entails breaking down seaweed cell wall at room temperature to expose agar as gelling agents and to modify the structure of the cellulose fiber by reducing its size and/or increasing the exposed surface area to obtain a natural seaweed composite material. Although high pressure homogenization is used in working examples of this disclosure, the technology is not limited to HPH but rather including any methods that can break down seaweed cell wall while maintaining agar in its un-melted, native state bound to the cellulose. Because agar is porous and permeable to aqueous and the particle size is small enough (less than 90 μm in diameter) to allow chemical and mechanical treatment of the bound cellulose, this process is compatible with other established methods to modify the structure and function of agar and the cellulose for specific applications. The manufacturing process may vary depending on the species of seaweeds and the desired properties of the final agar-cellulose composite materials.

In addition to increase gelling strength, alkali treatment can also destroy part of the pigment and protein in raw seaweed to facilitate decolorization and deproteinization. The alkali that can be used in the disclosed process include sodium hydroxide, potassium hydroxide, calcium hydroxide or the like. The concentration of the alkalis and processing conditions such as temperature and treatment time can vary. In general, the acid/base treatment, HPH and other processing steps can be carried out under various conditions and temperatures for different considerations as long as the agar is neither melted nor dissociated from its natural seaweed insoluble fiber matrix. For example, (A) a high alkali concentration at a low temperature (e.g., 20-30% sodium hydroxide at room temperature for 5-10 days), (B) a medium alkali concentration at a medium temperature (e.g., 20-30% sodium hydroxide at 60-70° C. for 1-4 hours), and (C) a low alkali concentration at a high temperature (e.g., 2-7% sodium hydroxide solution at 80-95° C. for 1-4 hours) can be used. Condition (C) requires a small amount of alkali and a short reaction time. However, the hydrocolloid is easily dissolved and lost, and the gelling strength and overall quality of the obtained seaweed composite material is slightly compromised. This process is suitable for large production due to its production efficiency. Condition (A) reduces the loss of hydrocolloid, and the gelling strength and quality of the seaweed composite material is improved, but the production cycle is long, the efficiency is low, and the consumption of alkali is high. The alkali treatment conditions can be further optimized based on the raw materials and the desired features of the final product.

Seaweed with or without alkali-treatment can be subjected to acid treatment. The acid is one or more of phosphoric acid, hydrochloric acid, sulfuric acid, oxalic acid, citric acid, lactic acid, malic acid, acetic acid, and the like. The acid treatment is carried out to remove some salt components in the seaweed, and/or to soften the seaweed for subsequent bleaching treatment. The acid treatment is generally carried out at 0-85° C., at a concentration of 0.1-1% (w/w), and the treatment time is between 10 minutes and 2 hours. The acid concentration and treatment time can vary based on the species of the raw seaweed materials. Excessive acid treatment may cause hydrocolloid loss and decreased gelling strength.

Bleaching treatment is optional and can remove the natural colorants in seaweed to enhance the whiteness of the product. Bleaching is usually carried out at room temperature. The bleaching agent is one or more of hydrogen peroxide, sodium hypochlorite, chlorine dioxide, and the like. Preferably, a sodium hypochlorite solution is used as the bleaching solution, the effective chlorine concentration is about 0.1-0.5%, and the treatment time is about 30 minutes to 2 hours.

The bleached seaweed can be dried first, coarsely pulverized, and then added to 0-85° C. water or 60-100° C. water to carry out high pressure homogenization. Alternatively, after removal of the bleaching agent the wet seaweed can be directly added to 0-85° C. water or 60-100° C. water for wet milling using colloid milling, followed by high pressure homogenization. The material homogenized in 0-85° C. water can be dried by centrifugation or pressure filtration, and then dried and pulverized into the final product. The material homogenized in 60-100° C. water needs to be cooled to form a gel first, then dewatering by pressure filtration or freeze dry by lyophilization. The dried sample is pulverized into the final product.

After alkali-treatment and high pressure homogenization, the homogenized seaweed liquid can be subjected to a second acid treatment to obtain low molecular weight agar containing seaweed composite materials having a low-gelling strength (e.g., a gelling strength 200 g/cm²). The second acid treatment can be carried out at a range of temperature (0-85° C.) for a longer period, for example, at an acid concentration of 0.1-3% (w/w) for 5-20 hours. It can also be carried out at a relatively high temperature (60-100° C.) for a short period of time, for example, at an acid concentration of 0.01-1.0% (w/w) for 0.5-2 hours.

Colloid mill is a type of wet milling equipment that can reduce particle size by shearing and milling. High pressure homogenization can reduce particle size by high mechanical shearing forces. HPH can also loosen the structure of certain materials including insoluble plant fibers through entropic effect resulting from the dramatic drop of pressure associated with HPH. Natural cellulose fiber from plants including seaweeds are usually densely packed resulting in hard texture, poor mouthfeel and water binding properties. HPH treatment has been used to modify various plant derived fibers in a dissociated state to reduce particle size, disrupt fibrous structure and increase surface area, thereby to enhance their food application quality (e.g. water binding and retention capacity and viscosity and stability etc.). Unexpectedly, as it is disclosed herein, HPH can achieve a significant effect on breaking down seaweed cellulose fiber in the presence of naturally bound agar. Thus, disclosed herein is a process of making a natural agar-cellulose composite material wherein the originally densely packed seaweed fiber bundles are broken into small fiber pieces even when the fiber is in a natural state associated with agar and the natural association is maintained despite of the shearing force of HPH.

After the dry-grind seaweed powder is dispersed in water, or wet-milled seaweed sample is obtained, it is filtered by a cloth of 40 mesh or more, more preferably, 80-100 mesh or more, to prepare the sample for HPH. The HPH can be carried out in a single pass or multiple passes. For a single pass, the homogenization pressure is preferably from 20 to 100 MPa, more preferably from 30 to 60 MPa. For multiple passes, the homogenization pressure is preferably from 10 to 60 MPa, more preferably from 20 to 40 MPa.

The drying process can be carried out in many different ways and is not limited by any particular method. The final product is pulverized to 80 mesh or more, more preferably to 200 mesh or more. The actual particle size can be determined by specific applications.

The following examples are intended to illustrate various embodiments of the invention. As such, the specific embodiments discussed are not to be construed as limitations on the scope of the invention. It will be apparent to one skilled in the art that various equivalents, changes, and modifications may be made without departing from the scope of invention, and it is understood that such equivalent embodiments are to be included herein. Further, all references cited in the disclosure are hereby incorporated by reference in their entirety, as if fully set forth herein.

### EXAMPLES

### Example 1: Preparation of a Seaweed Composite Material Having a High Gelling Strength

This example describes preparation of a seaweed composite material with high gelling strength via Process 1 including an alkali treatment followed by an acid treatment using Gracilaria lemaneiformis as the raw starting material. The seaweed composite materials were produced by washing and cleaning the dried raw seaweed in water before treatment with sodium hydroxide solution (5.0%, w/w) at a mass ratio of seaweed to sodium hydroxide solution of 1:20 (w/w dry weight of seaweed) for 2 hours at 85° C. The alkali treated seaweed was washed with water to neutral pH. Subsequently, the alkali treated seaweed was treated with an oxalic acid solution (0.2%, w/w) for 1 hour at 30° C., washed with water to neutral pH, and then bleached with a sodium hypochlorite solution (effective chlorine 0.2%) for 30 minutes. The seaweed was then washed with water to remove the bleaching reagent and to bring back to neutral pH. The treated and bleached seaweed was dried by hot air to a water content of about or less than 15%, and then pulverized to 200 mesh to obtain a seaweed powder. A small sample was taken and saved as Sample A-1, which served as an unhomogenized control.

The obtained seaweed powder was divided into two portions. A first portion of the obtained seaweed powder was dispersed in 30° C. water at a mass ratio of 1:50 (w/w dry weight of seaweed to water) and then homogenized by a high-pressure homogenizer at 25 MPa for one pass. The homogenized seaweed powder was subjected to pressure filtration dehydration and hot air drying to a water content of about or less than 15%, and then pulverized to 200 mesh to obtain the final seaweed composite material, Sample A-2 (normal temperature HPH).

A second portion of the obtained seaweed powder was dispersed in water at a mass ratio of 1:50 (w/w dry weight of seaweed to water), boiled for 5 minutes, and then homogenized at 80° C. by a high-pressure homogenizer at 25 MPa for one pass. The HPH step may be carried out at a temperature between 60° C. and 100° C. The homogenized sample was cooled to 25° C. to form a gel and freeze-dried. Subsequently, the sample was dried by hot air to a water content of about or less than 15% and then pulverized to 200 mesh to obtain the final seaweed composite material, Sample A-3 (high temperature HPH).

### Example 2: Preparation of a Seaweed Composite Material Having a Low Gelling Strength

This example describes preparation of a seaweed composite material with low gelling strength via Process 2 without any alkali treatment using G. lemaneiformis as the raw starting material. The seaweed composite materials were produced by washing and cleaning the dried raw seaweed in water. The cleaned seaweed was treated with a hydrochloric acid solution (0.2%, w/w) for 1 hour at 30° C., washed with water to neutral pH, and then bleached with a sodium hypochlorite solution (effective chlorine 0.2%) for 1 hour. The seaweed was then washed with water to remove the bleaching reagent and to bring back to neutral pH. The bleached seaweed was dried by hot air to a water content of about or less than 15%, and then pulverized to 200 mesh to obtain a seaweed powder. A small sample was taken and saved as Sample B-1, which served as an unhomogenized control.

The obtained seaweed powder was dispersed in 30° C. water at a ratio of 1:50 (w/w dry weight of seaweed) and then homogenized by a high-pressure homogenizer at 25 MPa for one pass. The homogenized seaweed powder was subjected to pressure filtration dehydration and hot air drying to a water content of about or less than 15%, and then pulverized to 200 mesh to obtain the final seaweed composite material, Sample B-2 (normal temperature HPH).

### Example 3: Preparation of a Seaweed Composite Material Having a Low Gelling Strength

This example describes preparation of a seaweed composite material with low gelling strength via Process 3 with an alkali treatment and double acid treatments using G. lemaneiformis as the raw starting material. The seaweed composite materials were produced by washing and cleaning the dried raw seaweed in water before treatment with sodium hydroxide solution (5.0%, w/w) at a mass ratio of seaweed to sodium hydroxide solution of 1:20 (w/w dry weight of seaweed) for 2 hours at 85° C. The alkali treated seaweed was washed with water to neutral pH. Subsequently, the alkali treated seaweed was treated with an oxalic acid solution (0.2%, w/w) for 1 hour at 30° C., washed with water to neutral pH, and then bleached with a sodium hypochlorite solution (effective chlorine 0.2%) for 30 minutes. The seaweed was then washed with water to remove the bleaching reagent and to bring back to neutral pH. The treated and bleached seaweed was dried by hot air to a water content of about or less than 15%, and then pulverized to 200 mesh to obtain a seaweed powder.

The obtained seaweed powder was divided into two portions. A first portion of the obtained seaweed powder was dispersed in 30° C. water at a ratio of 1:50 (w/w dry weight of seaweed) and then hydrochloric acid was added to 0.7% (w/w) to treat the dispersed seaweed powder for 15 hours at 30° C. NaOH was added after the treatment to adjust the pH to 7.0. After centrifugation dehydration, the solid material was dispersed in water to remove the salt, and then dehydrated by centrifugation, followed by hot air drying to a water content of about or less than 15%. The sample was pulverized to 200 mesh to obtain Sample C-1, which served as an unhomogenized control.

A second portion of the obtained seaweed powder was dispersed in 30° C. water at a ratio of 1:50 (w/w dry weight of seaweed) and then homogenized by a high-pressure homogenizer at 25 MPa for one pass. The homogenized seaweed powder was treated with hydrochloric acid (0.7% w/w) at 30° C. for 15 hours. NaOH was added after the acid treatment to adjust the pH to 7.0. After centrifugation dehydration, the solid material was dispersed in water to remove the salt, and then dehydrated by centrifugation, followed by hot air drying to a water content of about or less than 15%. The sample was pulverized to 200 mesh to obtain the final seaweed composite material, Sample C-2 (normal temperature HPH).

### Example 4: Analyses of Seaweed Composite Materials

The obtained seaweed composite materials, including the controls, were analyzed for their viscosity, gelling strength, stability, and particle size distribution, as described below.

Viscosity measurement: 2.0 g of a seaweed composite material sample or a control sample was added to 198 g of deionized water, heated to boil, and cooled to 80° C. The viscosity of the sample was measured at 80° C. using a Brookfield viscometer, spindle #61 at 12 RPM.

Gelling strength (g/cm²) determination: A stock solution of 1.5% (w/w) of each sample was prepared, boiled for 5 minutes, and then cooled to 20° C. and kept for 15 hours before being analyzed for gelling strength using a texture analyzer (Stable Micro System, TA.XT.Plus Texture Analyser), probe: P/0.5; pressing speed: 1.5 mm/s; running speed: 1.0 mm/s; recovery speed: 1.5 mm/s. The pressing distance was 20 mm.

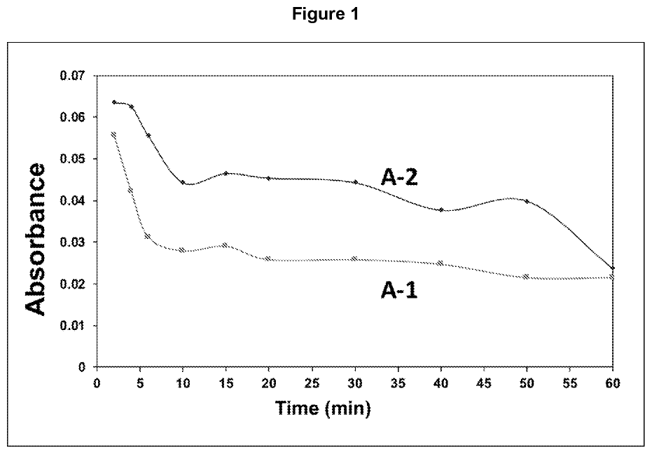

Stability of seaweed composite materials in aqueous solution: A 60 ml of 0.5% (w/w) solution of each of Sample A-1 (no HPH control) and Sample A-2 (normal temperature HPH) was prepared in deionized water, boiled for 10 minutes while stirring. Each sample was then left standing still at 50° C. Aliquots of the solution were sampled into cuvettes with 5 times of dilution at different time points. The light absorbance of the solution at different time points was measured at 600 nm using a DU® 640 spectrophotometer (Beckman Coulter). As shown in FIG. 1, HPH-treated Sample A-2 is significantly more stable than the unhomogenized Sample A-1, as evidence by the longer suspension stability of fiber particles (higher absorbance) in the solution.

As shown in FIG. 1, high-pressure homogenization (HPH) treatment greatly enhanced the suspension stability of the seaweed composite materials in water. After high-pressure homogenization, the suspension stability of Sample A-2 in water was significantly improved. By contrast, Sample A-1 obtained without HPH treatment demonstrated a quick precipitation of the insoluble components. Similar results were also obtained with the comparison between Samples B1 and B2, as well as between Samples C-1 and C-2 (data not shown).

To analyze the properties of the insoluble fiber, the insoluble fiber was isolated from Sample A-1 (no HPH) and Sample A2 (normal temperature HPH) to obtain Sample D-1 and Sample D-2, respectively. The isolation was done by boiling Sample A-1 and Sample A-2 to melt the soluble agar and centrifuge to isolate the insoluble fiber.

As shown in Table 1, the viscosity of Sample D-2 (normal temperature HPH) is significantly increased compared to Sample D-1 (no HPH). The viscosity of the 1% (w/w) sample increases from 32 mPa·s without HPH to 390 mPa·s with HPH, suggesting that HPH can dramatically change the properties and possibly the structure of the insoluble fiber in the agar-cellulose natural composite materials. Table 1 also shows that the viscosity of Samples A-2, B-2 and C-2, all with HPH processing, increased significantly compared to Samples A-1, B-1 and C-1, all without HPH processing. It is likely that the increase of viscosity in these samples is mainly caused by the increase of the viscosity of the insoluble fiber after HPH treatment.

TABLE 1
Properties of Seaweed Composite Materials

| | Viscosity | | Gelling | | |
|---|---|---|---|---|---|
| | (mPa · s) | | strength* | Insoluble fiber* | Soluble fiber* |
| | No HPH | HPH | g/cm² | (%) | (%) |
| Sample | 14 | 172 | 750 | 29.4 | 45.7 |
| A | | | | | |
| Sample | 19 | 180 | 70 | n/a | n/a |
| B | | | | | |
| Sample | 3.2 | 49 | 50 | 38.2 | 36.5 |
| C | | | | | |
| Sample | 32 | 390 | n/a | n/a | n/a |
| D | | | | | |

*The data is an average of the no HPH control and normal temperature HPH of each sample.

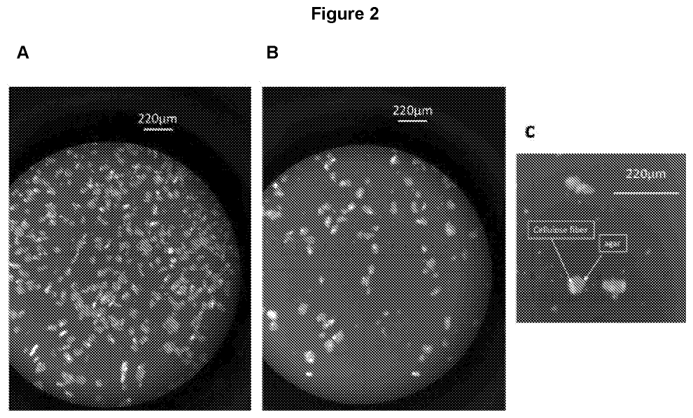

Imaging analyses of the seaweed composite materials were performed to determine the structure of the materials. The images of the seaweed composite materials were taken with a Leica light microscope equipped with polarized filter (model MZ125). FIG. 2 shows the imaging analyses of Sample A-2. At a certain polarization angle, the crystalline insoluble cellulose fiber showed a lighter color, as seen in the center and the edge of many agar-cellulose composite particles. The non-crystalline agar showed as an opaque color at the outer region of the composite particle. The smallest division in the image was 11 μm, so most of the particles appeared to have a size around 40-50 μm.

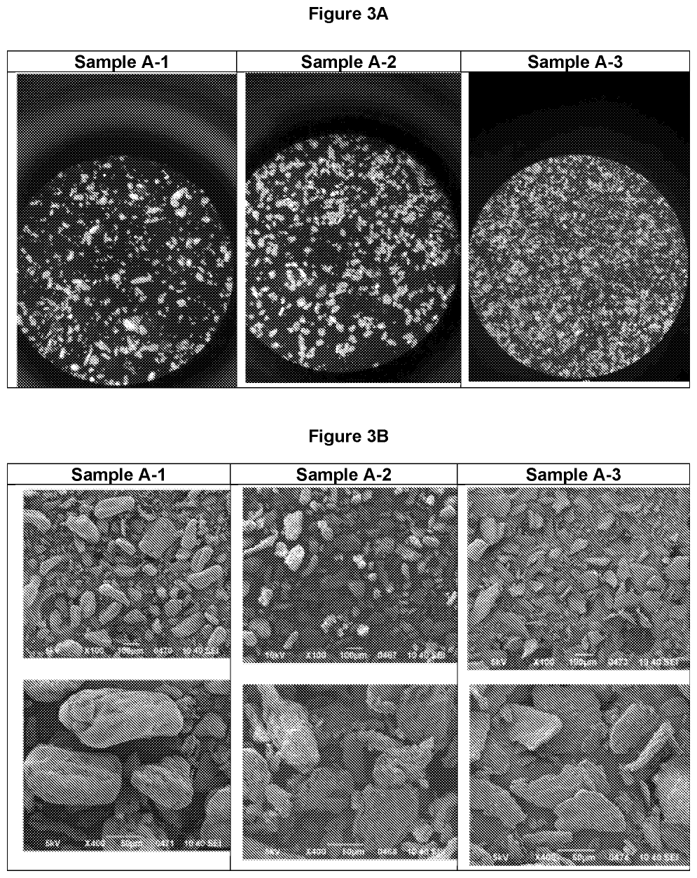

FIG. 3 shows the comparative imaging analysis of Samples A-1 (no HPH control), A-2 (normal temperature HPH at 30° C.), and A-3 (high temperature HPH at 80° C.). As shown in FIG. 3A, although all samples were pulverized by the same procedure, the particles from these three samples had very different structural features. Sample A-2 contained evenly distributed, grainy particles, many of which had the insoluble cellulose fiber (displayed as the bright spots) entirely or partially encapsulated by agar. By contrast, Sample A-3 contained flakes with a wide distribution of particle sizes and shapes, most of them were thin pieces of agar gel, while some others were almost entirely insoluble cellulose fiber particles. These observations suggest that Sample A-2 and Sample A-3 were structurally different although they were obtained by the same mechanical process of HPH. Sample A-2 was obtained at normal temperature without melting the agar to separate it from the insoluble cellulose fiber. Thus, Sample A-2 maintained at least some aspects of the natural structure or assembly mechanisms between agar and insoluble cellulose fiber. In contrast, the agar was melted and dissociated from the insoluble cellulose during the high temperature HPH process to obtain Sample A-3 and the gel was reformed after cooling. During the cooling process, the insoluble cellulose fiber, given their high binding function and the tendency to self-associate, they may form fiber clusters, leading to a mixture of pulverized particles, with some made of mostly agar gel, and some made of mostly cellulose fiber. For the non-homogenized control Sample A-1, the particles, though seemed to be grainy similar to Sample A-2, contained a mixture of particles, some with more fiber than others. This probably is due to the fact that in the natural seaweed cell wall, the cellulose fibers are bundled together. Additionally, the particles in Sample A-1 were not uniform in size and shape.

Consistent with light microscope analyses in FIG. 3A, the electron microscope images of FIG. 3B also reveal that Sample A-2 contained evenly distributed grainy particles, while Sample A-3 contained flakes with a wide distribution of sizes and shapes, most of which were in thin pieces. The non-homogenized control Sample A-1 also shows a wide distribution of particle sizes, but most of the particles were grainy solid particles similar to Sample A-2. Although EM images did not show the fiber structure inside the composite materials, the higher resolution images of EM did show that the surface structure of the particles from Sample A-2 was rough, likely due to high pressure homogenization, whereas the particles from non-homogenized control A-1 had a round and smooth surface.

These structural differences have important functional implications. In Sample A-2, HPH results in the insoluble cellulose fibers evenly distributed and stabilized by the agar naturally bound to the fibers. In Sample A-3, the insoluble cellulose fibers have the tendency to aggregate because the agar is melted and dissociated from the fibers. This aggregation tendency is more pronounced when the fiber is physically and/or chemically processed to alter its structure to increase surface area, binding activity and viscosity (see Sample D in Table 1).

Although the exact particle size and shape may vary depending on the type of raw seaweed materials used and processing conditions, comparison between Sample A-2 and Sample A-3 demonstrates that the natural agar-cellulose composite materials obtained by the disclosed technology involving physical break-down of seaweed cell wall via processes such as HPH is fundamentally different from the materials obtained by conventional processes involving melting agar and re-gelling. The natural seaweed composite materials disclosed herein has structural and functional features different from the seaweed materials obtained by conventional processes. For example, Sample A-2 has a melting point of 90° C., whereas Sample A-3 has a melting point of 100° C. The non-homogenized control Sample A-1 also shows a wide distribution of particle sizes, but most of the particles are grainy solid like Sample A-2. However, the structure of the A-1 particles are different from that of the A-2 particles: the former has the cellulose fiber distribute unevenly in the particles, with some (especially the large particles) have more cellulose fibers, where some (especially those small particles) seem to be entirely agar; and the latter has more uniform particles in size and shape, with insoluble cellulose fibers evenly distributed and stabilized by the agar naturally bound to the fibers.

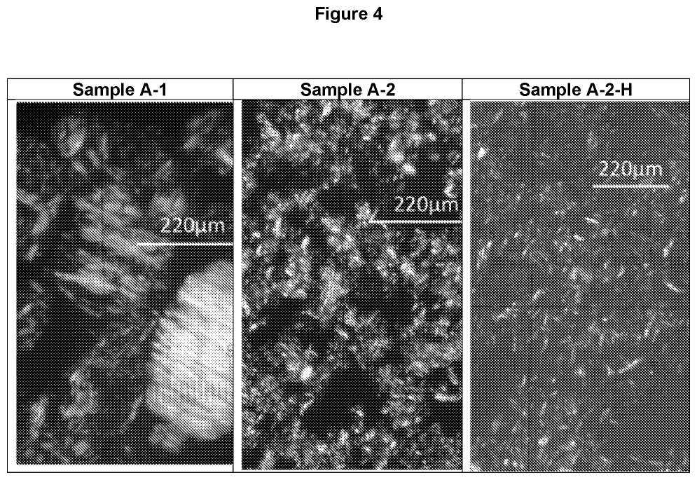

Comparative imaging analysis of cellulose fiber in different samples was performed to further explore the structural features of the natural seaweed composite materials disclosed herein. The cellulose fiber has a crystalline nature and can be observed under polarized light. A protocol was established to observe fiber structure in various agar-cellulose composite samples obtained by the methods described above. Briefly, a 1% (w/w) solution of each of Samples A-1, A-2 and A-2-H was boiled for 5 minutes and cooled down to form a gel. Sample A-2-H was obtained by subjecting Sample A-2 to an additional pass of HPH. A thin slice of the gel from each sample was placed under the microscope, and the polarizing filter was adjusted such that the fiber was brightly visible whereas the agar was invisible. As shown in FIG. 4, the fiber in the non-homogenized control A-1 had a densely and well packed structure wherein the individual fiber bundles were aligned along one axis. By contrast, after HPH at 30° C., the fiber structure was completely disrupted into a randomly-scattered pieces. When an additional pass of HPH was performed on Sample A-2 to obtain Sample A-2-H, the fibers in Sample A-2-H were further broken down into small pieces. These observations suggest that after alkali and acid treatments in Process 1, simple mechanical grinding, though seemingly capable of reducing the size of the seaweed composite material particles, was not effective in disrupting the structure of cellulose fiber in seaweed cell wall. Surprisingly, HPH at 25° C. was able to disrupt the cellulose fiber structure, and the degree of disruption can be adjusted by HPH settings including pressure, orifice size, and number of passes. This result was unexpected considering that agar was not melted throughout this process and remained bound to the cellulose during HPH.

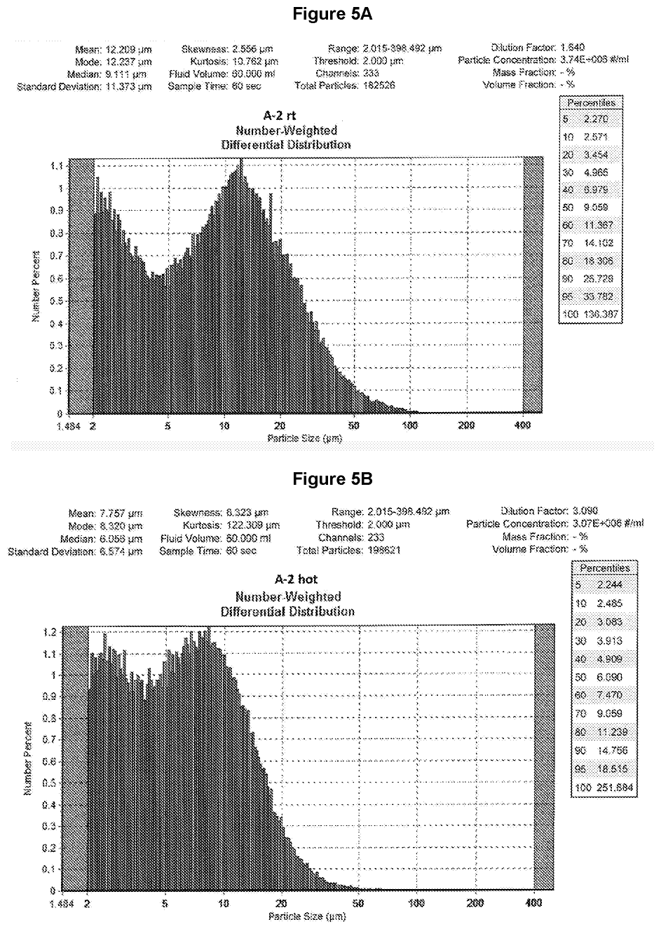

To further characterize the natural seaweed composite materials comprising insoluble cellulose fiber and agar bound thereto, particle size analysis of Sample A-2 was performed under various conditions using the Particle Sizing Systems Accusizer (Model 780 AD, range 1-1000 μm) using the Extinction mode. Sample A-2 was suspended in water at 1% (w/w) and subjected to room temperature HPH (25 Mpa, one pass, at 25° C.) to ensure full dispersion of the sample before particle size analysis. FIG. 5A shows the particle size distribution of Sample A-2 at room temperature.

Furthermore, the particle size analysis was performed at a high temperature by suspending Sample A-2 in water at 1% (w/w), boiling for 5 minutes to melt the agar, and keeping at 60° C. Then Sample A-2 was subjected to HPH for one pass (25 Mpa) and particle size analysis was performed at 60° C. FIG. 5B shows the particle size distribution of Sample A-2 at 60° C.

Table 2 below shows a summary of the particle size analysis.

TABLE 2
Particle Size Analysis

| | CUMULATIVE NUMBER | | | NUMBER |
|---|---|---|---|---|
| SAMPLE | % LESS THAN INDICATED SIZE | | | WEIGHTED |
| ID | d[n, 0.10](μm) | D[n, 0.50](μm) | D[n, 0.90](μm) | MEAN |

Dietary Fiber

| | | | | |
|---|---|---|---|---|
| A-2 rt | 2.57 | 9.06 | 25.73 | 12.21 |
| A-2 hot | 2.49 | 6.09 | 14.76 | 7.76 |

Sample A-2 in the natural composite agar-cellulose form (A-2 rt) had a larger particle size D90 (25.73 μm) than A-2 hot (after boiling to melt agar) D90 (14.76 μm). These particle size analyses reveal the general configuration of agar-cellulose composite materials, while the exact structural features will vary depending on the raw starting seaweed materials and the processing methods used.

1. A natural seaweed composite material comprising one or more insoluble fibers and agar, wherein the agar is associated with the insoluble fiber.

2. The natural seaweed composite material of claim 1, wherein the insoluble fiber comprises cellulose and insoluble hemicellulose.

3. The natural seaweed composite material of claim 1, wherein the agar is bound to the surface of the insoluble fiber.

4. The natural seaweed composite material of claim 1, wherein the insoluble fiber is partially or entirely encapsulated by the agar.

5. The natural seaweed composite material of claim 1, wherein the insoluble fiber is partially or entirely embedded within the agar.

6. The natural seaweed composite material of claim 1, wherein the natural seaweed composite material is obtained from red algae.

7. The natural seaweed composite material of claim 1, wherein the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm.

8. The natural seaweed composite material of claim 1, wherein the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.

9. A method of making a natural seaweed composite material from red algae, comprising the steps of:
treating the fresh or dried seaweed with one or more acids,
grinding the acid-treated seaweed by wet milling or dry grinding,
subjecting the ground seaweed to high pressure homogenization (HPH), and
drying and grinding the homogenized seaweed powder to a desired particle size to obtain the natural seaweed composite material.

10. The method of claim 9, wherein the HPH is carried out at a temperature of between 0° C. and 85° C.

11. The method of claim 9, the HPH is carried out at room temperature.

12. The method of claim 9, the seaweed is washed and/or cleaned to remove debris before the acid treatment.

13. The method of claim 9, the seaweed is bleached by one or more bleaching agents before HPH.

14. The method of claim 9, further comprises treating the fresh or dried seaweed with one or more alkalis before the acid treatment to obtain a natural seaweed composite material having a high gelling strength.

15. The method of claim 14, further comprises a step of a second acid treatment after HPH treatment to obtain a natural seaweed composite material having a low gelling strength.

16. A natural seaweed composite material produced by the method of claim 9.

17. The natural seaweed composite material of claim 16, comprises one or more insoluble fibers and agar, wherein the agar is associated with the insoluble fiber.

18. The natural seaweed composite material of claim 17, wherein the insoluble fiber comprises cellulose and insoluble hemicelluloses.

19. The natural seaweed composite material of claim 17, wherein the insoluble fiber is associated with agar in a manner similar to the association in the natural state in seaweed before processing.

20. The natural seaweed composite material of claim 17, wherein the agar is bound to the surface of the insoluble fiber such as cellulose of the natural seaweed composite material.

21. The natural seaweed composite material of claim 17, wherein the insoluble fiber is entirely or partially embedded within agar.

22. The natural seaweed composite material of claim 17, wherein the insoluble fiber is partially or entirely encapsulated by agar.

23. The natural seaweed composite material of claim 17, wherein the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm.

24. The natural seaweed composite material of claim 17, wherein the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.
